(19) United States
(12) Patent Application Publication
(10) Pub. No.: US 2020/0181354 A1
(43) Pub. Date: Jun. 11, 2020

(54) SEPARATION AND COLLECTION APPARATUS OF PLASTIC-BASED COMPLEX WASTE

(71) Applicant: EARTHRECYCLE CO., LTD., Hyogo (JP)

(72) Inventor: Takashi TACHIBANA, Hyogo (JP)

(21) Appl. No.: 16/215,678

(22) Filed: Dec. 11, 2018

(51) Int. Cl. C08J 11/18; B29B 17/02

(52) U.S. Cl. CPC C08J 11/18; B29B 17/02; B29B 2017/0293; B29B 2017/0244; B29B 2017/0255; B29B 2017/0203

(57) ABSTRACT

The present invention provides a separation and collection apparatus of plastic-based complex waste in which plastic-based complex waste is separated into a floating plastic component, a dissolving plastic component, and a sinking component and collected, wherein a glycol is reacted with the dissolving plastic component to make a melt in a dissolution and separation reservoir 10, thereby plastic-based complex waste 20 is separated into a floating plastic component 20A, a dissolving plastic component 20B, and a sinking component 20C.

### CROSS-REFERENCE TO THE RELATED APPLICATION

This application is related to the Chinese application No. 201710456342.8 filed on Jun. 16, 2017.

### BACKGROUND OF THE INVENTION

### Field of Invention

The present invention relates to continuous separation and collection method and apparatus of plastic-based complex waste and particularly to an apparatus that separates a variety of plastic-based complex wastes, such as complex electric product waste of metal and plastic, car waste, medical waste, blend product waste of a synthetic fiber and a natural fiber, and complex plastic-based water such as FRP by batch or continuously, into different kinds of plastic components such as a floating plastic component which floats on the separating agent, a dissolving plastic component which dissolves in a separating agent, and a sinking component including a plastic component and a non-plastic-based component which sinks in a separating agent.

### Background Art

As waste plastic, there are thermoplastic resins and thermosetting resins, a lot of methods for separating these resins using the specific weight are frequently employed, and thermoplastic resins are broadly recycled.

On the other hand, the recycling of thermosetting resins is difficult. For example, an epoxy resin-cured substance is excellent in terms of electric characteristics, thermal resistance, and adhesiveness and is thus used in a broad range of fields such as insulating materials, adhesives, and paint, but the thermal decomposition is difficult, and thus the recycling is difficult.

In addition, regarding medical waste, waste of kidney dialysis sets or drip infusion sets includes body fluids such as blood or injection needles, has a high risk of infection, and thus includes a large amount of a polyvinyl chloride (hereinafter, referred to as PVC) resin or metal in a material, which makes medical waste one of wastes of which treatments are most difficult.

In addition, metal-containing plastic products, for example, a variety of electric products such as OA devices, portable terminals, televisions, vacuum cleaners, and refrigerators, particularly, printed-wiring assemblies that are used in control portions of the electric products, furthermore, fusion pipe joints, resin-coated electric wires, optical cables, and the like are frequently manufactured to be integrated with a metal material.

In the case of disposing of and reusing the above-described metal-containing plastic products or defective products produced in the manufacturing step thereof, there is a demand for cleanly and efficiently separating the metal material and the plastic material. In terms of such a demand, a variety of proposals regarding a treatment method in which a plastic material of a metal-containing plastic product is heated, dissolved, and thus separated from a metal material or the like have been made (Patent Document 1 and Patent Document 2).

In addition, a method for treating a metal-containing plastic product enabling the safe and efficient heating and dissolution of a plastic material in oil in the treatment of the metal-containing plastic product has been proposed (Patent Document 3).

Recently, in electric components or electronic components, there have been a number of cases in which an electric circuit such as a semiconductor circuit is formed on a substrate of a thermosetting resin such as an epoxy resin; however, in the case of such a thermosetting resin, it is difficult to effectively differentiate and collect a metal material and a resin material.

In addition, as waste of which recycling is difficult, a variety of complex plastic wastes are emerging. For example, an aluminum/polypropylene (hereinafter, referred to as PP)/polyethylene terephthalate (hereinafter, referred to as PET) three-layer sheet, a polyethylene (hereinafter, referred to as PE)/PET carpet, a silver layer/PET sheet-laminated X-ray film, a nylon/PET bottle, a PET/cotton/nylon/acryl-blended cloth, a lead-attached fish net, an electric wire, PVC paper, and the like are known.

These complex plastic wastes are diversely classified. Some of waste is difficult to be incinerated, on the other hand, some of waste can be incinerated, but cannot be easily separated and collected and thus cannot be reused, and the like.

In contrast, the present inventors proposed a separation and collection method of plastic-based complex waste in which, in a treatment of plastic-based complex waste, an ethylene glycol is used as a reaction initiator, a dissolving plastic component is heated and melted, thereby forming a reaction melt, the plastic-based complex waste is separated into a plastic-based component and a non-plastic-based component using the reaction melt as a separation solvent, and the plastic-based component separated using the reaction melt is separated into a floating plastic component, a dissolving plastic component, and a sinking component and collected (Patent Document 4).

### RELATED ART DOCUMENT

### Patent Document

Patent Document 1: JP-A-5-147041
Patent Document 2: JP-A-10-137734
Patent Document 3: JP-A-2008-213480
Patent Document 4: WO2014/098229

### SUMMARY OF THE INVENTION

### Technical Problem

In the method described in Patent Document 4, it is expected that components such as plastic and a metal material are separated and collected and can be effectively used without incinerating medical waste or complex plastic waste including an FRP resin, but there has been a demand for developing a system enabled to be operated in actual use.

The present invention has been made in consideration of such a circumstance, and an object of the present invention is to provide separation and collection method and apparatus of plastic-based complex waste enabling the separation and collection of components such as plastic and a metal material from medical waste or complex plastic waste including an FRP resin and the effective use of the components.

### Solution Problem

According to the present invention, there is provided a separation and collection method of plastic-based complex waste, which separates the plastic-based complex waste into a floating plastic component, a dissolving plastic component, and a sinking component and collects each components of the plastic-based complex waste, which comprises comprising:
a) a dissolution and separation step for making a melt as the separating agent obtained by reacting a glycol with the dissolving plastic component, and then separating the plastic-based complex waste to be added therein into a floating plastic component which floats on the separating agent, a dissolving plastic component which dissolves in the separating agent, and a sinking component including a plastic component and a non-plastic-based component which sink in the separating agent using separating agent at a high-temperature and a normal pressure;
b) a floating plastic component-receiving step for receiving the floating plastic component from the dissolution and separation reservoir and supplying the floating plastic component as a pellet raw material and/or a petrochemical raw material;
c) a transferring step for transferring the floating plastic component toward an extraction portion in the dissolution and separation reservoir;
d) a separating agent-receiving step for extracting the dissolving plastic component and the separating agent from the dissolution and separation reservoir;
e) a heating step for heating the separating agent to a predetermined temperature range in a separating agent-receiving reservoir;
f) a circulation step for circulating the separating agent in the predetermined high temperature range in the separating agent-receiving reservoir to the dissolution and separation reservoir so as to maintaining the separating agent in the dissolution and separation reservoir at a high temperature;
g) a withdrawal step for withdrawing the sinking component from a bottom portion of the dissolution and separation reservoir;
h) an evaporation step for evaporating the separating agent circulated using the circulation pump in the separating agent-receiving reservoir and receiving a mixed plastic component of an evaporated residue in a receiving reservoir;
i) a condensing step for condensing the evaporated separating agent which is returned to the separating agent-receiving reservoir;
j) a vacuum evaporation step for receiving the mixed plastic component in the receiving reservoir, wherein the glycol is evaporated in a vacuum, and the mixed plastic component is separated as a raw material for a pellet; and
k) a another condensing for condensing the glycol separated by means of vacuum evaporation and returning it to the separating agent-receiving reservoir.
   On the other hand, the apparatus includes
   1) a dissolution and separation reservoir in which a melt can be obtained by reacting a glycol with the dissolving plastic component and stored as a separating agent, so that the plastic-based complex waste to be injected is separated into a floating plastic component which floats on the separating agent, a dissolving plastic component which dissolves in the separating agent, and a sinking component including a plastic component and a non-plastic-based component which sinks in the separating agent using the high-temperature separating agent at normal pressure,
   2) a floating plastic component-receiving reservoir for receiving the floating plastic component extracted from the dissolution and separation reservoir and supplying the received floating plastic component as a pellet raw material and/or a petrochemical raw material,
   3) a transfer blade that transfers the floating plastic component toward an extraction portion in the dissolution and separation reservoir, a separating agent-receiving reservoir that extracts and receives the dissolving plastic component and the separating agent from the dissolution and separation reservoir,
   4) a heating furnace that heats the separating agent in the separating agent-receiving reservoir to a predetermined temperature range,
   5) a circulation pump that circulates the separating agent in the predetermined temperature range in the separating agent-receiving reservoir to the dissolution and separation reservoir so that the separating agent in the dissolution and separation reservoir is maintained at a high temperature,
   6) a withdrawal screw that withdraws the sinking component from a bottom portion of the dissolution and separation reservoir, an evaporation reservoir that evaporates the separating agent from a part of the separating agent in the separating agent-receiving reservoir which is circulated using the circulation pump and receives a mixed plastic component of an evaporated residue in a receiving reservoir,
   7) a condenser that condenses the evaporated separating agent and returns the separating agent to the separating agent-receiving reservoir,
   8) a vacuum evaporation reservoir that receives the mixed plastic component in the receiving reservoir, evaporates the glycol in a vacuum, and separates the mixed plastic component as a raw material for a pellet, and
   9) a condenser that condenses the glycol separated by means of vacuum evaporation and returns the glycol to the separating agent-receiving reservoir.

According to another embodiment of the present invention, there is provided a separation and collection apparatus of plastic-based complex waste, which separates the plastic-based complex waste into a floating plastic component, a dissolving plastic component, and a sinking component and collects the plastic-based complex waste, the apparatus including

1) a swelling reservoir in which a melt obtained by reacting a glycol with the dissolving plastic component and one selected from the group of methyl isobutyl ketone, cyclohexanone, and cyclohexane or a xylene-mixed liquid thereof are received as a swelling agent and plastic-based complex waste is swollen at normal pressure,
2) a cage into which the plastic-based complex waste is injected and which is moved up and down with respect to the swelling reservoir so as to immerse the plastic component in the swelling agent in the swelling reservoir, swell the plastic component, and separate a non-plastic component,
3) a dissolution and separation reservoir in which a melt obtained by reacting a glycol with the dissolving plastic component is stored as a separating agent, and a plastic component of the plastic-based complex waste which is swollen and from which a non-plastic component is separated and plastic-based mixed waste is separated into a floating plastic component which floats on the separating agent, a dissolving plastic component which dissolves in the separating agent, a sinking component including a plastic component and a non-plastic-based component which sinks in the separating agent using the high-temperature separating agent at normal pressure,
4) a cage into which the plastic-based complex waste which is swollen and from which a non-plastic component is separated and the plastic-based mixed waste are injected and which is moved up and down with respect to the dissolution and separation reservoir so as to immerse the plastic-based complex waste and the plastic-based mixed waste in the separating agent in the dissolution and separation reservoir, dissolve the dissolving plastic component in the separating agent in the dissolution and separation reservoir, and separate the floating plastic component and the sinking component,
5) a separating agent-receiving reservoir that extracts and receives the dissolving plastic component and the separating agent from the dissolution and separation reservoir, a heating furnace that heats the separating agent in the separating agent-receiving reservoir to a predetermined temperature range, a circulation pump that circulates the separating agent in the predetermined temperature range to the separating agent-receiving reservoir in the dissolution and separation reservoir so that the separating agent in the dissolution and separation reservoir is maintained at a high temperature, an evaporation reservoir that evaporates the separating agent from a part of the separating agent in the separating agent-receiving reservoir which is circulated using the circulation pump and receives a mixed plastic component in a receiving reservoir,
6) a condenser that condenses the evaporated separating agent and returns the separating agent to the separating agent-receiving reservoir,
7) a vacuum evaporation reservoir that receives the mixed plastic component in the receiving reservoir, evaporates the glycol in a vacuum, and separates the mixed plastic component as a raw material for a pellet, and
8) a condenser that condenses the glycol separated by means of vacuum evaporation and returns the glycol to the separating agent-receiving reservoir.

According to the 3^{rd} embodiment of the present invention, there is provided a separation and collection apparatus of plastic-based complex waste, which separates the plastic-based complex waste into a floating plastic component, a dissolving plastic component, and a sinking component and collects the plastic-based complex waste, the apparatus including

1) a mixing reservoir in which a melt obtained by reacting a glycol with the dissolving plastic component is stored as a separating agent and plastic-based complex waste to be injected is mixed,
2) a screw that extracts the plastic-based complex waste from the mixing reservoir, a dissolution and separation reservoir in which a melt obtained by reacting a glycol with the dissolving plastic component is stored as a separating agent, and extracted plastic-based complex waste is separated into a floating plastic component which floats on the separating agent, a dissolving plastic component which dissolves in the separating agent, and a sinking component including a plastic component and a non-plastic-based component which sinks in the separating agent using the high-temperature separating agent at normal pressure and which includes
3) a screw that extracts the floating plastic component,
4) a floating plastic component-receiving reservoir for receiving the floating plastic component extracted from the dissolution and separation reservoir and supplying the received floating plastic component as a pellet raw material and/or a petrochemical raw material, a separating agent-receiving reservoir that extracts and receives the dissolving plastic component and the separating agent from the dissolution and separation reservoir,
5) a heating furnace that heats the separating agent in the separating agent-receiving reservoir to a predetermined temperature range,
6) a circulation pump that circulates the separating agent in the predetermined temperature range to the separating agent-receiving reservoir in the dissolution and separation reservoir and the mixing reservoir so that the separating agent in the dissolution and separation reservoir and the separating agent in the mixing reservoir are maintained at a high temperature,
7) a screw that extracts the sinking component from a bottom portion of the dissolution and separation reservoir, and an evaporation reservoir that evaporates the separating agent from a part of the separating agent in the separating agent-receiving reservoir which is circulated using a circulation pump and receives a mixed plastic component that is used as a raw material for a pellet in a receiving reservoir.

One of characteristics of the present invention is that plastic-based complex waste is separated into the floating plastic component, the dissolving plastic component, and the sinking component using the high-temperature separating agent in the dissolution and separation reservoir at normal pressure, the separating agent is withdrawn from the dissolution and separation reservoir and received in the separating agent-receiving reservoir, and the separating agent in the separating agent-receiving reservoir is heated to the predetermined temperature range using the heating furnace and circulated to the dissolution and separation reservoir.

Therefore, the high-temperature separating agent in the dissolution and separation reservoir is circulated at all times and maintained in a state in which the separating agent is capable of separating plastic-based complex waste, and it becomes possible to continuously or intermittently separate plastic-based complex waste by continuously or intermittently injecting the plastic-based complex waste.

A second characteristic of the present invention is that a separating agent obtained by causing a reaction of a dissolving plastic component selected from the group consisting of a polyethylene terephthalate (PET)-based resin, a polyurethane (PU)-based resin, a polycarbonate (PC)-based resin, and a polyamide (PA)-based resin using a glycol, for example, ethylene glycol, diethylene glycol, or tri-ethylene glycol as a reaction initiator is used.

A resin melt that is formed by reacting with glycols has a higher boiling point than glycols that are used as a decomposition initiator, for example, ethylene glycol, and thus a capability of separating a plastic component and a non-plastic component such as metal is maintained, a floating plastic component suitable for petrochemical production such as PP, PE, or PS can be separated, other plastic components are dissolved, an epoxy resin can be separated by means of depolymerization and vacuum evaporation, and PVC and the like can be sunk and collected.

For example, the boiling point of ethylene glycol is 186□, but the boiling point of a melt liquid of ethylene glycol and PET reaches 220□ C in a weight-based blend of 50:50 and reaches 288□ C in a weight-based blend of 5:95, and the boiling points of a melt liquid of tri-ethylene glycol (TEG) and a plastic component are as described below.

| Blended amount (with respect to EG) | 50 wt % | 95 wt % |
|---|---|---|
| PET | 221° C. | 288° C. |
| PC | 350° C. | 372° C. |
| PU | 360° C. | 370° C. |
| PET | 221° C. | 288° C. |
| PC | 350° C. | 372° C. |
| PU | 360° C. | 370° C. |

Here, regarding the boiling points, the temperature of the liquid at which one droplet was dropped from the outlet during distillation at normal pressure was considered as the boiling point. Therefore, an increase in the boiling point of a solvent is extremely practical since the treatment efficiency improves, and it is also possible to collect glycols while decreasing the amount of the glycols used.

In addition, a separating agent having a high boiling point of 300□ C or higher is capable of shortening the treatment time and suitable for FRP or substrate treatments.

Examples of the plastic-based complex waste include medical waste, car waste, fish nets, solar panels, mobile phones, home appliances, complex materials of plastic and non-plastic, for example, fire hoses or fiber reinforced plastic, and the like. Examples of the non-plastic component include metal materials, non-metal materials, semiconductor materials, reinforced fibers such as carbon fibers, glass fibers, boron fibers, and aramid fibers, and the like.

Before a step of heating and separating the plastic-based complex waste in the separating agent, it is also possible to carry out a preliminary treatment in which the plastic-based complex waste is immersed in a heating bath of a pretreatment agent made of one selected from the group of methyl isobutyl ketone, cyclohexanone, and cyclohexane or a xylene-mixed liquid thereof and a plastic component is swollen (or dissolved), thereby differentiating the plastic component from other non-plastic components in advance.

Polyvinyl chloride (PVC) can be dissolved by being immersed in a bath in which cyclohexanone (cyclohexane) or a liquid mixture of cyclohexanone (cyclohexane) and xylene (80 wt % or less of xylene) is heated to 90□ C to 100□ C at normal pressure, whereby polyvinyl chloride can be used in a preliminary treatment of wallpaper or car window frames.

PVC can be immersed and swollen in a bath in which methyl isobutyl ketone (MIBK) or a liquid mixture of methyl isobutyl ketone and xylene (20 to 80 wt % of MIBK) is heated to 70□ C at normal pressure, which can be applied to a preliminary treatment for removing a circuit board from a portable terminal or a solar panel.

In a case in which the plastic-based complex waste includes PVC, it is also possible to sink a PVC component in the separating agent and differentiate the PVC component from a floating plastic component or a dissolving plastic component or heat the PVC component in the separating agent under the addition of an alkali agent, sink the PVC component together with a desalination treatment, differentiate the PVC component from the floating plastic component or the dissolving plastic component, and collect the PVC component.

In this case, it is possible to carry out the desalination treatment in a temperature range of 220□ C to 310□ C and sink the PVC component. In addition, the injection of an alkali agent neutralizes the reaction system, and thus the formation of dioxane is prevented, which is preferable. In addition, in a separating agent of 220□ C or lower, the desalination treatment is not carried out, and, simply, PVC is sunk.

In a case in which the plastic waste is medical waste, it is preferable to set the temperature in the separation reservoir to a temperature at which PVC does not decompose, for example, 220□ C or lower and separate and collect a plastic component and a metal component together with a sterilization treatment.

The separating agent including the dissolving plastic component is evaporated in a vacuum (at a reduced pressure), whereby glycols that are unreacted volatile components can be collected and reused.

### BRIEF DESCRIPTION OF THE DRAWINGS

FIG. 1 is an overall configuration view illustrating a preferred embodiment of a separation and collection apparatus of plastic-based complex waste according to the present invention.

FIG. 2 is a schematic plan view illustrating a structural example of a dissolution and separation reservoir in the embodiment.

FIG. 3 is an overall configuration view illustrating a second embodiment.

FIG. 4 is an overall configuration view illustrating a third embodiment.

### DETAILED DESCRIPTION OF THE PREFERRED EMBODIMENT

Hereinafter, the present invention will be described in detail on the basis of a specific example illustrated in drawings. In a separation and collection apparatus of plastic complex waste, examples of waste 20 that can be continuously or intermittently injected into a dissolution and separation reservoir 10 include Al/PET/PE-based complex materials, carpets, X-ray films, medical infectious exhaust plastic, glass fiber FRP (GFRP), carbon fiber FRP (CFRP), electric substrates, electronic substrates, plastic for a car, old clothes, and the like.

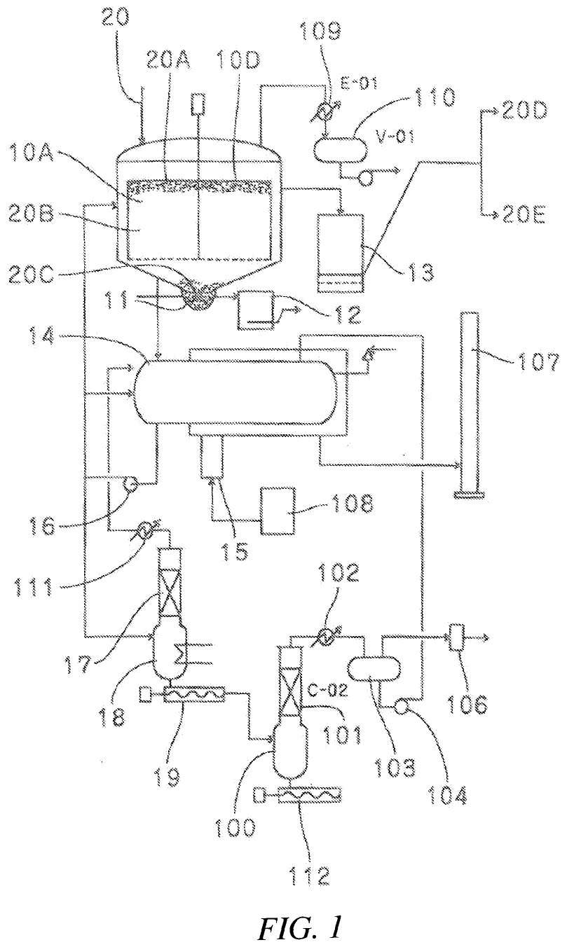

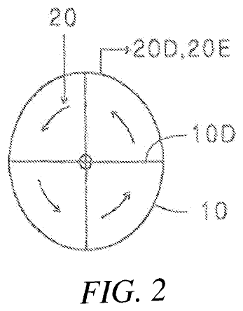

FIGS. 1 and 2 illustrate a preferred embodiment of a separation and collection apparatus of plastic-based complex waste according to the present invention. In the drawings, 10 indicates a dissolution and separation reservoir in which a resin melt obtained by reacting tri-ethylene glycol (TEG) with at least one selected from the group of a PET resin, a PU resin, a PC resin, and a PA resin is stored as a separating agent 10A.

The plastic-based complex waste 20 is continuously or intermittently injected into the dissolution and separation reservoir 10, the injected plastic-based complex waste 20 is separated into a floating plastic component 20A including a PP resin, a PE resin, and a PS resin which floats on the separating agent 10A, a dissolving plastic component 20B including a PET resin, a PU resin, a PC resin, a PA resin, and an epoxy resin depolymerized under the addition of an alkali agent which dissolves in the separating agent 10A, and a sinking component 20C including thermosetting plastic such as a PVC resin and a non-plastic-based component such as a metal material, a non-metal material, a glass fiber, a carbon fiber (fibrillated film yarn), a boron fiber, an aramid fiber, a filler, cotton, marijuana, and acryl which sinks in the separating agent 10A using the separating agent 10A at normal pressure and 210□ C to 300□ C.

A withdrawal screw 11 that withdraws the sinking component 20C is provided in a bottom portion of the dissolution and separation reservoir 10, and the withdrawn sinking component is received in a receiving reservoir 12 and is used as, for example, a pellet raw material.

A condenser 109 that condenses an evaporated component of the separating agent 10A is connected to an upper portion of the dissolution and separation reservoir 10, and the condensed separating agent 10A is received in a receiving reservoir 110.

In addition, a floating plastic component-receiving reservoir 13 that receives the withdrawn floating plastic component 20A is provided in the dissolution and separation reservoir 10, and the floating plastic component 20A is used as a pellet raw material 20D or a petrochemical raw material 20E.

Furthermore, a separating agent-receiving reservoir 14 that receives the extracted separating agent 10A in the dissolution and separation reservoir 10 is provided in the dissolution and separation reservoir 10. A heating furnace 15 is provided in the separating agent-receiving reservoir 14, a fuel oil tank 108 is connected to the heating furnace 15, and the heating furnace 15 heats the separating agent 10A in the separating agent-receiving reservoir 14 to a predetermined temperature, for example, a temperature in a range of 210□ C to 300□ C, and exhaust gas from the heating furnace 15 is discharged through a chimney 107.

The high-temperature separating agent 10A in the separating agent-receiving reservoir 14 is circulated to the dissolution and separation reservoir 10 using a circulation pump 16, and the separating agent 10A in the dissolution and separation reservoir 10 is maintained at a predetermined temperature.

In addition, a part of the high-temperature separating agent 10A from the circulation pump 16 is sent to an evaporation reservoir 17, an unreacted separating agent is evaporated, condensed using a condenser 111, and returned to the separating agent-receiving reservoir 14, and a mixed plastic component included in the separating agent 10A is received in a receiving reservoir 18 in the evaporation reservoir 17, heated using a heater, and sent to a vacuum evaporation reservoir 101 using a screw 19.

In the vacuum evaporation reservoir 101, unreacted TEG is evaporated in a vacuum (at a low pressure), the mixed plastic component is separated, the unreacted TEG is condensed using a condenser 102, received in a receiving reservoir 103, and returned to the separating agent-receiving reservoir 14 using a pump 104, and the mixed plastic component is withdrawn from a reservoir portion of a receiving reservoir 100 using a screw 112 and used as a pellet raw material.

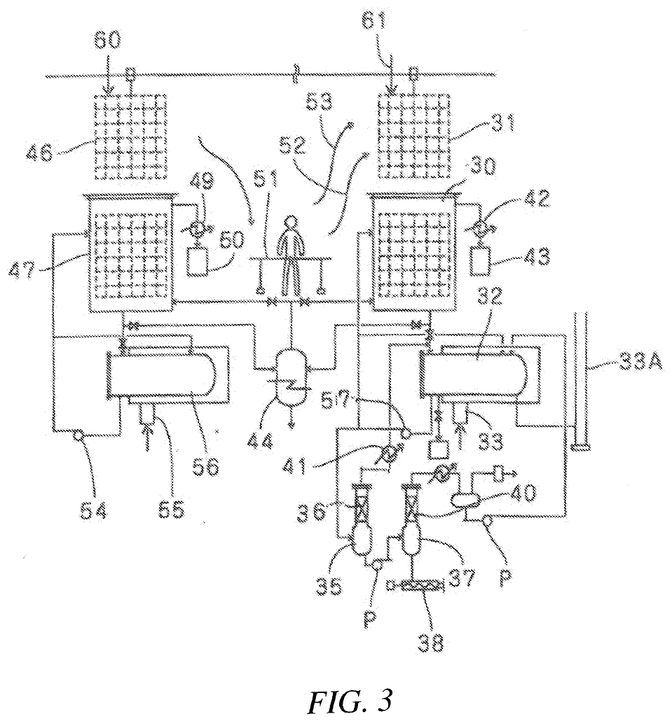

FIG. 3 illustrates a second embodiment of the separation and collection apparatus of plastic-based complex waste of the present invention. In the drawing, 47 indicates a swelling reservoir in which a melt obtained by reacting tri-ethylene glycol (TEG) with at least one selected from the group of a PET resin, a PU resin, a PC resin, and a PA resin and also one selected from the group of methyl isobutyl ketone, cyclohexanone, and cyclohexane or a xylene-mixed liquid thereof are stored as swelling agents and plastic-based complex waste 60 is swollen at normal pressure.

In the swelling reservoir 47, a plastic component of the plastic-based complex waste 60 is swollen to a state in which the plastic component can be separated from a non-plastic component using the swelling agents at normal pressure and 200□ C or lower.

A cage 46 is provided so as to be capable of moving up and down in the swelling reservoir 47, the plastic-based complex waste 60, for example, a small-sized home appliance, an electronic substrate, or an electric substrate is injected into the cage 46 in a state of being crushed or not crushed, the swollen plastic-based complex waste 60 is removed using the cage 46, and a non-plastic component and a plastic component, for example, an empty substrate 52 or an IC chip 53 are differentiated on a work table 51.

A condenser 49 that condenses an evaporated component of the swelling agents is connected to an upper portion of the swelling reservoir 47, and the condensed swelling agents are received in a receiving reservoir 50. In addition, a swelling agent-receiving reservoir 56 that receives the swelling agents in which the plastic component is dissolved, is provided in the swelling reservoir 47, and the swelling agents in the swelling agent-receiving reservoir 56 are heated using a heating furnace 15 and circulated to the swelling agent-receiving reservoir 56 using a circulation pump 54.

In a dissolution and separation reservoir 30, a melt obtained by reacting tri-ethylene glycol (TEG) with at least one selected from the group of a PET resin, a PU resin, a PC resin, and a PA resin is stored as a separating agent, a plastic component of the swollen plastic-based complex waste 60, for example, the empty substrate 52 or the IC chip 53 and plastic-based complex waste 61, for example, glass fiber reinforced plastic (GFRP) waste or carbon fiber reinforced plastic (CFRP) waste are separated into a floating plastic component including a PP resin, a PE resin, and a PS resin which floats on a separating agent, a dissolving plastic component including a PET resin, a PU resin, a PC resin, a PA resin, and a depolymerized epoxy resin which dissolves in the separating agent, and a sinking component including thermosetting plastic such as a PVC resin and a non-dissolving component such as a metal material, a non-metal material, a glass fiber, a carbon fiber (fibrillated film yarn), a boron fiber, an aramid fiber, a filler, cotton, marijuana, and acryl resin which sinks in the separating agent using the separating agent at normal pressure and 210□ C to 250□ C.

A cage 31 is provided so as to be capable of moving up and down in the dissolution and separation reservoir 30, a plastic component of the swollen plastic-based complex waste 60 or the plastic-based complex waste 61, for example, glass fiber reinforced plastic (GFRP) waste or carbon fiber reinforced plastic (CFRP) waste is injected into the cage 31 in a state of being crushed or not crushed, and the floating plastic component and the sinking component can be collected by moving the cage 31 up.

A condenser 42 that condenses an evaporated component of the separating agent is connected to an upper portion of the dissolution and separation reservoir 30, and the condensed separating agent is received in a receiving reservoir 43.

In addition, a separating agent-receiving reservoir 32 that receives the separating agent in which the plastic component is dissolved, is provided in the dissolution and separation reservoir 30, a heating furnace 33 is provided in the separating agent-receiving reservoir 32, and the heating furnace 33 heats the separating agent in the separating agent-receiving reservoir 32 to a predetermined temperature, for example, a temperature in a range of 210□ C to 300□ C, and exhaust gas from the heating furnace 33 is discharged through a chimney 33A.

The high-temperature separating agent in the separating agent-receiving reservoir 32 is circulated to the dissolution and separation reservoir 30 using a circulation pump 57, and the separating agent in the dissolution and separation reservoir 30 is maintained at a predetermined temperature.

In addition, a part of the high-temperature separating agent from the circulation pump 57 is sent to an evaporation reservoir 36, the separating agent is evaporated and separated into a mixed plastic component and unreacted TEG, the evaporated separating agent is condensed using a condenser 41 and returned to the separating agent-receiving reservoir 32, and the separated mixed plastic component and an unreacted separating agent are received in a receiving reservoir 35 and heated using a heater.

The unreacted TEG in the receiving reservoir 35 is evaporated in a vacuum, condensed in a vacuum evaporation reservoir 40, and returned to the separating agent-receiving reservoir 32, and the mixed plastic component is extracted using a screw 38 and used as a pellet raw material.

Meanwhile, in the drawing, 44 indicates a receiving tank of a washing liquid that flows out when the plastic-based complex waste is washed.

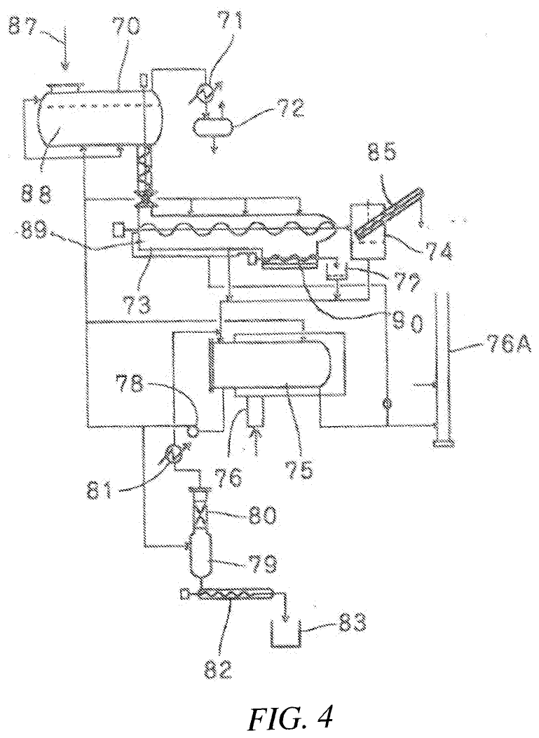

FIG. 4 illustrates a third embodiment. In the drawing, 70 indicates a mixing reservoir in which a resin melt obtained by reacting tri-ethylene glycol (TEG) with at least one selected from the group of a PET resin, a PU resin, a PC resin, and a PA resin is stored as a separating agent 88.

Plastic-based complex waste 87 is continuously or intermittently injected into the mixing reservoir 70 in a state of being crushed or not crushed, and the injected plastic-based complex waste 87 is mixed using the separating agent at normal pressure and 210□ C to 300□ C.

A condenser 71 that condenses evaporated moisture is provided in the mixing reservoir 70, and the condensed moisture is received in a moisture-receiving reservoir 72.

The plastic-based complex waste 87 in the mixing reservoir 70 is sent to a dissolution and separation reservoir 73 using a screw. In a dissolution and separation reservoir 73, a resin melt obtained by reacting tri-ethylene glycol (TEG) with at least one selected from the group of a PET resin, a PU resin, a PC resin, and a PA resin is stored as a separating agent 89 and separated into a floating plastic component including a PP resin, a PE resin, and a PS resin which floats on the separating agent 89, a dissolving plastic component including a PET resin, a PU resin, a PC resin, a PA resin, and an epoxy resin depolymerized under the addition of an alkali agent which dissolves in the separating agent 89, and a sinking component including thermosetting plastic such as a PVC resin and a non-plastic-based component such as a metal material, a non-metal material, a glass fiber, a carbon fiber (fibrillated film yarn), a boron fiber, an aramid fiber, a filler, cotton, marijuana, and acryl resin, which sinks in the separating agent 89.

A screw that extracts the floating plastic component is provided in an upper portion of the dissolution and separation reservoir 73, and the floating plastic component is received in a receiving reservoir 74, sent to a transfer device 85, and used as a pellet raw material or a petrochemical raw material.

In addition, a screw that extracts the sinking component is provided in a bottom portion of the dissolution and separation reservoir 73, and the extracted sinking component is received in a receiving reservoir 77.

A separating agent-receiving reservoir 75 that extracts the separating agent 89 that has dissolved the dissolving plastic component is provided in the dissolution and separation reservoir 73, a heating furnace 76 is provided in the separating agent-receiving reservoir 75, the heating furnace 76 heats the separating agent in the separating agent-receiving reservoir 75 to a predetermined temperature, for example, a temperature in a range of 210□ C to 300□ C, and exhaust gas from the heating furnace 76 is discharged through a chimney 76A.

The high-temperature separating agent in the separating agent-receiving reservoir 75 is circulated to the dissolution and separation reservoir 73 and the mixing reservoir 70 using a circulation pump 78, and the separating agents 88 and 89 in the dissolution and separation reservoir 73 and the mixing reservoir 70 are maintained at a predetermined temperature.

In addition, a part of the high-temperature separating agent from the circulation pump 78 is sent to an evaporation reservoir 80, the unreacted separating agent is evaporated, condensed using a condenser 81, and returned to the separating agent-receiving reservoir 75, and a mixed plastic component that is included in the separating agent is received in a receiving reservoir 79 in the evaporation reservoir 80, heated using a heater, extracted using a screw 82, and sent to a receiving reservoir 83.

What is claimed is:

1. A method for separating a plastic-based complex waste into a floating plastic component, a dissolving plastic component, and a sinking component by using a separating agent and collecting each of plastic components separately from the separating agent, comprising:
l) a dissolution and separation step for making a melt as the separating agent obtained by reacting a glycol with the dissolving plastic component, and then separating the plastic-based complex waste to be added therein into a floating plastic component which floats on the separating agent, a dissolving plastic component which dissolves in the separating agent, and a sinking component including a plastic component and a non-plastic-based component which sink in the separating agent using separating agent at a high-temperature and a normal pressure;
m) a floating plastic component-receiving step for receiving the floating plastic component from the dissolution and separation reservoir and supplying the floating plastic component as a pellet raw material and/or a petrochemical raw material;
n) a transferring step for transferring the floating plastic component toward an extraction portion in the dissolution and separation reservoir;
o) a separating agent-receiving step for extracting the dissolving plastic component and the separating agent from the dissolution and separation reservoir;
p) a heating step for heating the separating agent to a predetermined temperature range in a separating agent-receiving reservoir;
q) a circulation step for circulating the separating agent in the predetermined high temperature range in the separating agent-receiving reservoir to the dissolution and separation reservoir so as to maintaining the separating agent in the dissolution and separation reservoir at a high temperature;
r) a withdrawal step for withdrawing the sinking component from a bottom portion of the dissolution and separation reservoir;
s) an evaporation step for evaporating the separating agent circulated using the circulation pump in the separating agent-receiving reservoir and receiving a mixed plastic component of an evaporated residue in a receiving reservoir;
t) a condensing step for condensing the evaporated separating agent which is returned to the separating agent-receiving reservoir;
u) a vacuum evaporation step for receiving the mixed plastic component in the receiving reservoir, wherein the glycol is evaporated in a vacuum, and the mixed plastic component is separated as a raw material for a pellet; and
v) a another condensing for condensing the glycol separated by means of vacuum evaporation and returning it to the separating agent-receiving reservoir.

2. The method for separating a plastic-based complex waste into a floating plastic component, a dissolving plastic component, and a sinking component by using a separating agent and collecting each of plastic components separately from the separating agent, according to any one of claim 1,
wherein the floating plastic component is at least one selected from the group of a polypropylene (PP)-based resin, a polyethylene (PE)-based resin, and a polystyrene (PS)-based resin, the dissolving plastic component is at least one selected from the group of a polyethylene terephthalate (PET)-based resin, a polyurethane (PU)-based resin, a polycarbonate (PC)-based resin, and a polyamide (PA)-based resin, and the sinking component is at least one selected from the group of a polyvinyl chloride (PVC)-based resin and a non-plastic-based component.

3. The method for separating a plastic-based complex waste into a floating plastic component, a dissolving plastic component, and a sinking component by using a separating agent and collecting each of plastic components separately from the separating agent, according to any one of claim 1,
wherein the separating agent is a melt obtained by reacting the dissolving plastic component selected from the group of a polyethylene terephthalate (PET)-based resin, a polyurethane (PU)-based resin, a polycarbonate (PC)-based resin, and a polyamide (PA)-based resin with a glycol.

4. An apparatus for separating a plastic-based complex waste into a floating plastic component, a dissolving plastic component, and a sinking component by using a separating agent and collecting each of plastic components separately from the separating agent, comprising:
w) a dissolution and separation reservoir for making a melt as the separating agent obtained by reacting a glycol with the dissolving plastic component, and then separating the plastic-based complex waste to be added therein into a floating plastic component which floats on the separating agent, a dissolving plastic component which dissolves in the separating agent, and a sinking component including a plastic component and a non-plastic-based component which sink in the separating agent using separating agent at a high-temperature and a normal pressure;
x) a floating plastic component-receiving reservoir for receiving the floating plastic component from the dissolution and separation reservoir and supplying the floating plastic component as a pellet raw material and/or a petrochemical raw material;
y) a transfer blade that transfers the floating plastic component toward an extraction portion in the dissolution and separation reservoir;
z) a separating agent-receiving reservoir for extracting the dissolving plastic component and the separating agent from the dissolution and separation reservoir;
aa) a heating furnace for heating the separating agent to a predetermined temperature range in the separating agent-receiving reservoir;
bb) a circulation pump for circulating the separating agent in the predetermined high temperature range in the separating agent-receiving reservoir to the dissolution and separation reservoir so as to maintaining the separating agent in the dissolution and separation reservoir at a high temperature;
cc) a withdrawal screw for withdrawing the sinking component from a bottom portion of the dissolution and separation reservoir;
dd) an evaporation reservoir for evaporating the separating agent circulated using the circulation pump in the separating agent-receiving reservoir and receiving a mixed plastic component of an evaporated residue in a receiving reservoir;
ee) a condenser for condensing the evaporated separating agent which is returned to the separating agent-receiving reservoir;
ff) a vacuum evaporation reservoir for receiving the mixed plastic component in the receiving reservoir, wherein the glycol is evaporated in a vacuum, and the mixed plastic component is separated as a raw material for a pellet; and
gg) a condenser for condensing the glycol separated by means of vacuum evaporation and returning it to the separating agent-receiving reservoir.

5. An apparatus for separating a plastic-based complex waste into a floating plastic component, a dissolving plastic component, and a sinking component by using a separating agent and collecting each of plastic components separately from the separating agent, comprising:
a) a swelling reservoir for making a swelling agent by mixing a melt obtained by reacting a glycol with the dissolving plastic component, with a liquid selected from the group of methyl isobutyl ketone, cyclohexanone, and cyclohexane or a xylene-mixed liquid thereof and swelling plastic-based complex waste at normal pressure;
b) a moving cage for separating the plastic-based complex waste into the plastic component and the non-plastic component by using the swelling agent in the swelling reservoir;
c) a dissolution and separation reservoir for storing a melt as the separating agent obtained by reacting a glycol with the dissolving plastic component, and separating from the plastic component of the plastic-based complex waste without the non-plastic component and a plastic-based mixed waste into a floating plastic component which floats on the separating agent, a dissolving plastic component which dissolves in the separating agent, a sinking component including a plastic component and a non-plastic-based component which sinks in the separating agent using the separating agent at a high-temperature and a normal pressure;
d) a moving cage with respect to the dissolution and separation reservoir for swelling the plastic-based complex waste so as to separate a non-plastic component and immersing the plastic-based mixed waste an the dissolution and separation reservoir, so as to dissolve the dissolving plastic component in the separating agent in the dissolution and separation reservoir, in order to separate the floating plastic component and the sinking component from the dissolving component;
e) a separating agent-receiving reservoir for extracting and receiving the dissolving plastic component and the separating agent from the dissolution and separation reservoir;
f) a heating furnace for heating the separating agent in the separating agent-receiving reservoir to a predetermined temperature range;
g) a circulation pump for circulating the separating agent in the predetermined temperature range to the separating agent-receiving reservoir in the dissolution and separation reservoir so as to maintaining the separating agent in the dissolution and separation reservoir at a high temperature;
h) an evaporation reservoir for evaporating the separating agent partially in the separating agent-receiving reservoir while receiving a mixed plastic component in a receiving reservoir;
i) a condenser for condensing the evaporated separating agent and returning the separating agent to the separating agent-receiving reservoir;
j) a vacuum evaporation reservoir for receiving the mixed plastic component in the receiving reservoir, evaporating the glycol in a vacuum, and separating the mixed plastic component as a raw material for a pellet; and
k) a condenser for condensing the glycol separated by means of vacuum evaporation and returning the glycol to the separating agent-receiving reservoir.

6. An apparatus for separating a plastic-based complex waste into a floating plastic component, a dissolving plastic component, and a sinking component by using a separating agent and collecting each of plastic components separately from the separating agent, comprising:
a) a mixing reservoir for making a melt obtained by reacting a glycol with the dissolving plastic component as a separating agent and mixing plastic-based complex waste to be injected a screw for extracting the plastic-based complex waste from the mixing reservoir;
b) a dissolution and separation reservoir for making a melt obtained by reacting a glycol with the dissolving plastic component as a separating agent, and separating the extracted plastic-based complex waste into a floating plastic component which floats on the separating agent, a dissolving plastic component which dissolves in the separating agent, and a sinking component including a plastic component and a non-plastic-based component which sinks in the separating agent using the high-temperature separating agent at normal pressure and which includes a screw that extracts the floating plastic component;
c) a floating plastic component-receiving reservoir for receiving the floating plastic component extracted from the dissolution and separation reservoir and supplying the received floating plastic component as a pellet raw material and/or a petrochemical raw material;
d) a separating agent-receiving reservoir for extracting and receiving the dissolving plastic component and the separating agent from the dissolution and separation reservoir;
e) a heating furnace for heating the separating agent in the separating agent-receiving reservoir to a predetermined temperature range;
f) a circulation pump for circulating the separating agent in the predetermined temperature range to the separating agent-receiving reservoir in the dissolution and separation reservoir and the mixing reservoir so as to maintain the separating agent in the dissolution and separation reservoir and the separating agent in the mixing reservoir at a high temperature;
g) a screw for extracting the sinking component from a bottom portion of the dissolution and separation reservoir; and
h) an evaporation reservoir for evaporating the separating agent partially in the separating agent-receiving reservoir while circulating using a circulation pump and receiving a mixed plastic component used as a raw material for a pellet in a receiving reservoir.
